(19) United States
(12) Patent Application Publication
(10) Pub. No.: US 2021/0233408 A1
(43) Pub. Date: Jul. 29, 2021

(54) PARKING LOT SAFETY APPARATUS AND METHOD

(71) Applicant: Continental Automotive Systems, Inc., Auburn Hills, MI (US)

(72) Inventor: Vivian Swan, Auburn Hills, MI (US)

(21) Appl. No.: 16/751,377

(22) Filed: Jan. 24, 2020

(51) Int. Cl. G08G 1/16; G08G 1/14

(52) U.S. Cl. CPC G08G 1/168; G08G 1/14

(57) ABSTRACT

A method monitors availability of parking spaces in a parking lot and warns of a possible collision of a vehicle with an object in the parking lot. The method senses availability of vehicle parking spaces in an area of the parking lot and identifies one or more objects in or near a parking space, in between occupied parking spaces, or in a roadway portion of the area of the parking lot. Based on the sensing step, the availability of parking spaces in the area of the parking lot is identified. Based on the sensing step, the driver of the vehicle, the vehicle itself, and/or the one or more objects is warned of a possible collision between the vehicle and the one or more objects. An apparatus for performing the method is also provided.

### FIELD

This disclosure relates to vehicle parking lot accident prevention and, more particularly, to an apparatus and method for detecting pedestrians and/or objects in a parking lot and to warn of a potential collision with a vehicle.

### BACKGROUND

Conventional radar or camera solutions are mounted in parking lots to count available parking spaces and provides an indicator, such as an illuminated green light over the space that is available. There may be times when a pedestrian, bicyclist, or other object may be in or near the open parking space with the driver of the approaching vehicle unaware of the space intrusion, which can result in a possible collision.

Thus, there is a need to provide an apparatus and method for detecting pedestrians and/or objects in a parking lot and to warn of a potential collision with a vehicle.

### SUMMARY

An objective of an embodiment is to fulfill the need referred to above. In accordance with the principles of an embodiment, this objective is obtained by providing an apparatus for monitoring availability of parking spaces in a parking lot and warning of a possible collision of a vehicle with an object in the parking lot. The apparatus includes a controller. At least one sensor is electrically connected with the controller and is constructed and arranged to detect availability of vehicle parking spaces in the parking lot and to identify one or more objects in or near parking spaces, in a roadway portion of the parking lot, or in between occupied spaces. At least one identifying module is electrically connected with the controller. The identifying module, based on data from the at least one sensor, is constructed and arranged to identify the availability of parking spaces in an area of the parking lot. Based on data from the at least one sensor, the controller is constructed and arranged to originate an information signal to warn the driver of the vehicle, the vehicle itself, and/or the one or more objects of a possible collision between the vehicle and the one or more objects.

In accordance with another aspect of an embodiment, a method is provided for monitoring availability of parking spaces in a parking lot and warning of a possible collision of a vehicle with an object in the parking lot. The method senses availability of vehicle parking spaces in an area of the parking lot and identifies one or more objects, in or near a parking space, in between occupied parking spaces, or in a roadway portion of the area of the parking lot. Based on the sensing step, availability of parking spaces in the area of the parking lot is identified. Based on the sensing step, the driver of the vehicle, the vehicle itself, and/or the one or more objects is warned of a possible collision between the vehicle and the one or more objects.

Other objectives, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings, wherein like reference numerals refer to like parts, in which:

FIG. 1 is an overhead view of a parking lot with a having an apparatus for warning a pedestrian and/or vehicle driver of a possible collision in or near a parking space, in accordance with an embodiment.

FIG. 2 is a schematic view of the apparatus of FIG. 1.

FIG. 3 is a flowchart of method steps of an embodiment.

### DETAILED DESCRIPTION OF THE EXEMPLARY EMBODIMENTS

The following description of the preferred embodiment(s) is merely exemplary in nature and is in no way intended to limit the invention, its application, or uses.

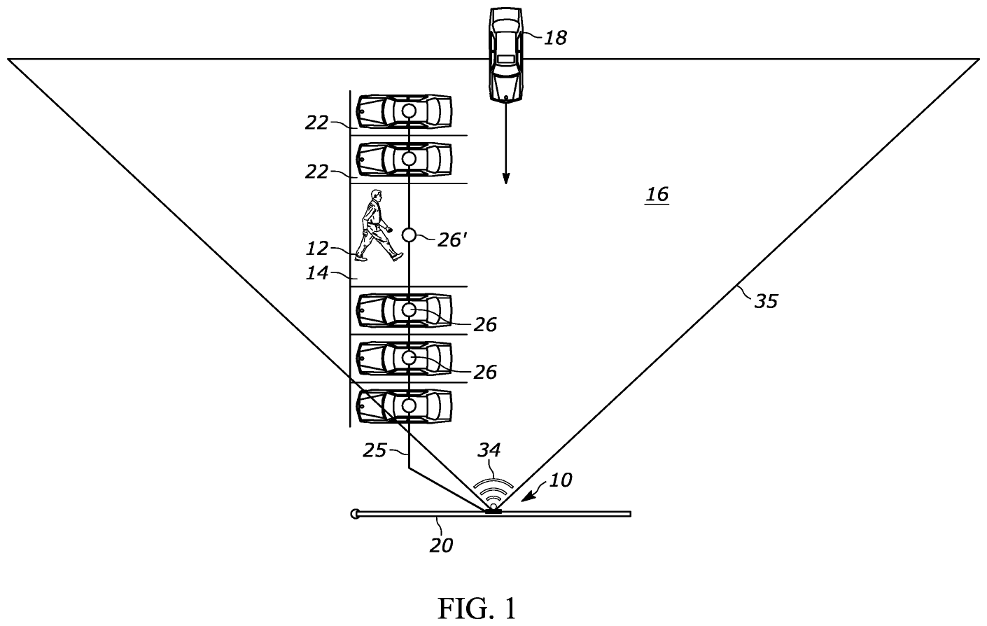

An example of an apparatus for detecting information about different vehicles and vulnerable objects 12 is shown in the Figures generally at 10. With reference to FIG. 1, the vulnerable object 12 may be a pedestrian, another vehicle, a bicyclist, a pet, a shopping cart, or other object (other than a vehicle) that is in or near a parking space 14 in a parking lot 16 or in a roadway of the parking lot 16, or in between occupied spaces of the parking lot. A vehicle 18 is shown approaching an open parking space 14 which may result in a collision with the pedestrian or vulnerable object 12 in or near the open parking space 14.

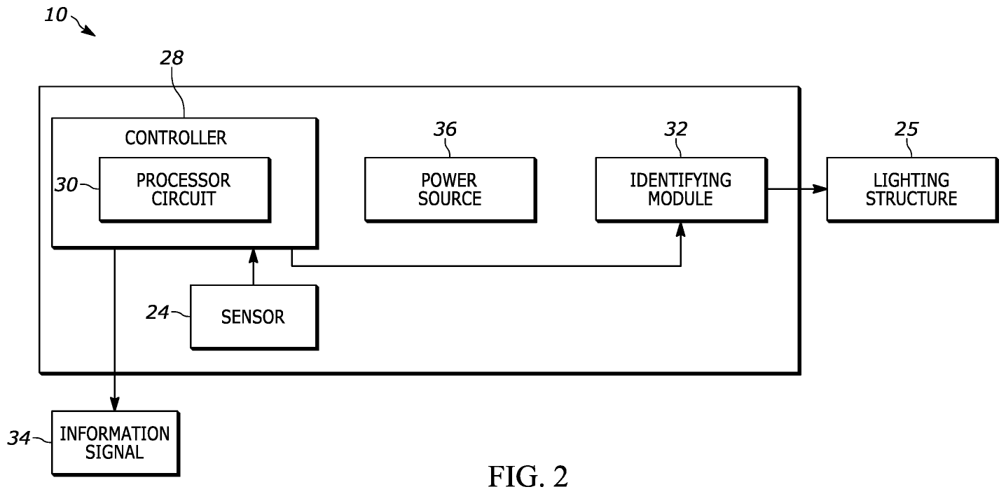

With reference to FIG. 1, the apparatus 10 is attached to some type of infrastructure component 20, which, in this embodiment, is preferably a wall, ceiling or post or other support structure adjacent to the parking lot 16. With reference to FIGS. 1 and 2, the apparatus 10 includes at least one sensor 24, which, in this embodiment, is able to detect occupied parking spaces 22 and open parking spaces 14 in the parking lot 16. In one embodiment, the apparatus 10 can include a lighting structure 25 coupled with the apparatus 10 that includes a light 26, preferably disposed above each parking space . The apparatus 10 includes a controller 28 having a processor circuit 30. The controller 28 is connected with an identifying module 32 that is connected with an identifying device such as a lighting structure 24 either in a wired or wireless manner. Thus, based on the sensor 24 data, the controller 28 signals the identifying module 32 to illuminate the light 26 above occupied parking spaces 22 red, and illuminate the light 26′ above open parking spaces 14, green, and thus identify the open parking space 14 in a conventional manner.

Alternatively, the identifying module 32 can be configured as communication device that is enabled for transmitting information wirelessly regarding available parking spaces, detected vehicles 18 and the vulnerable objects 12. In one embodiment, the identifying module 32, as a communication device, is a dedicated short range communication (DSRC) or cellular-V2X device, but it is within the scope of the invention that other types of communication devices maybe used. In one embodiment, each of the vehicles 18, may be equipped with a V2X-enabled communication device, suitable for communication with the identifying module 32, but it is within the scope of the invention that other types of communication, such as LTE or WiFi, may be used. The identifying module 32, in this embodiment, can thus broadcast to the vehicle 18, the location of one or more open parking spaces 14 in the parking lot 16. Furthermore, if the vehicle 18 is operating in a self-parking or autonomous mode, upon receiving the DSRC or V2X signal, the vehicle 18 can be more effectively navigate to an open parking space since the vehicle is provided with warnings when a vulnerable object 12 is present along the route.

In one embodiment, the sensor 24 is a radar sensor 24, but it is within the scope of the invention that other types of sensors may be used, such as, but not limited to LIDAR (Light Imaging, Detection, and Ranging), LADAR (Laser Imaging, Detection, and Ranging), other types of radar, a camera, ultrasound, or sonar. Thus, the sensor 24 can detect the location, speed, and direction of any approaching vehicle 18 in a detection area 35 (FIG. 1) and can simultaneously detect the location, speed, and direction of a vulnerable object 12 in an open parking space 14 or in a roadway of the parking lot 16.

In one embodiment the sensor 24, identifying module 32 and controller 28 are integrated into the apparatus 10 as a single component or a single unit. The integration of the controller 28, sensor 24, and identifying module 32 as an apparatus 10 in a single component provides the advantage of more easily facilitating installation to various infrastructure components such as on walls of vehicle garages, or poles in outside parking lots. However, it is within the scope of this invention that sensors 24 are separate components or that the controller 28 is hosted on a virtual machine (e.g., connected to the apparatus via the internet). In this way, a single computation unit (controller 28 with processor circuit 30) can be provided for multiple sensors 24 that are located separately in the same parking lot, or the computation could take place in the cloud when an internet connection is provided.

Thus, to prevent the collision mentioned above, the sensor 24 is able to detect the location, as well as speed and direction of the approaching vehicle 18, and the location, speed, and direction of each vulnerable object 12 in or near an open parking space 14, in between occupied parking spaces, or in a roadway of the parking lot 16. While there is one vulnerable object (pedestrian) walking in or near a parking space 14 in the embodiment, it is within the scope of the invention that the sensor 24 is able to detect if the vulnerable object 12 is walking, traveling by bicycle, scooter, skateboard, rollerblades, or the like, or is a stationary object in or near an open parking space, in between occupied parking spaces, or in the roadway of the parking lot.

Once the sensor 24 detects the location, as well as speed and direction of the approaching vehicle 18, and the location, speed, and direction of a vulnerable object 12 in an open parking space 14 or roadway portion of the parking lot 16, the controller 28 generates an informational signal 34, which may be an alert signal or an information signal to driver of the vehicle 18 and/or to the vulnerable object 12. The controller 28 may be equipped to send out different types of information signals 34, such as, but not limited to, an audible sound warning, a visual warning, or a haptic warning. In the embodiment shown in FIG. 1, the information signal 34 is an audible warning to alert the vulnerable objects 12 and the driver of vehicle 18 that there is a potential risk of collision with a vehicle 18. Alternatively, when the identifying module 32 is a communication device, the controller 28 can cause the identifying module 32 to broadcast an audible information signal 34, or the information can be communicated to the driver through the vehicle HMI or through a smart phone.

The apparatus 10 has power source 36 which can be wired into an AC source of the infrastructure or can be a battery. In the embodiment, the power source, as a battery, is integrated along with the other components into the apparatus 10, but can be mounted separately from the apparatus 10 if desired. Alternatively, the power source 36 may be a solar panel if the apparatus 10 is mounted outside.

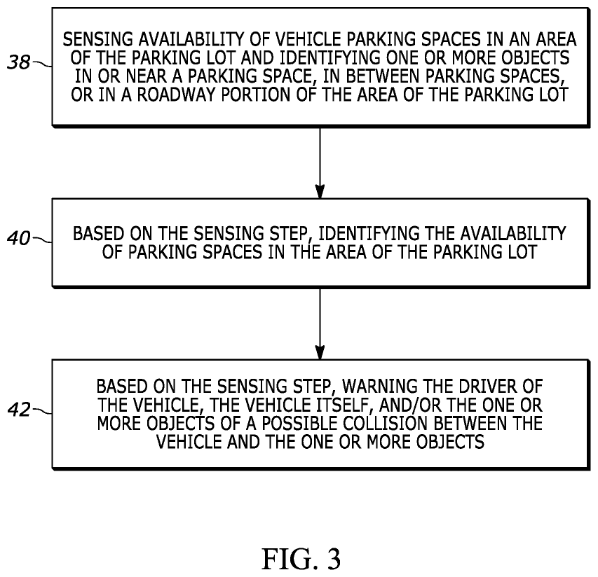

With reference to FIG. 3, a method is provided for monitoring availability of parking spaces in a parking lot and warning of a possible collision of a vehicle with an object in the parking lot in accordance with an embodiment. In step 38, the method senses availability of vehicle parking spaces in an area of the parking lot and identifies one or more objects in or near at a parking space, in between occupied parking spaces e or in a roadway portion of the area of the parking lot. In step 40, based on the sensing step, the availability of parking spaces in the area of the parking lot is identified. In step 42, based on the sensing step, the driver of the vehicle, the vehicle itself, and/or the one or more objects is warned of a possible collision between the vehicle and the one or more objects.

Thus, the apparatus 10 detects open parking spaces in a parking lot for vehicle drivers or automated vehicles and also advantageous detects, with the same apparatus, pedestrians or objects also in the parking lot and warns the pedestrian, vehicle, and/or the driver whose vehicle is approaching the pedestrian or objects so as to prevent a possible collision.

Various implementations of the apparatus and techniques described here (e.g., processor circuit 30, identifying module 32) can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable apparatus including at least one programmable processor, which may be special or general purpose, coupled to receive data and instructions from, and to transmit data and instructions to, a storage apparatus, at least one input device, and at least one output device.

These computer programs (also known as programs, software, software applications, or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter affecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management apparatus, an operating apparatus, or a combination of one or more of them. A propagated signal is an artificially generated signal, e.g., a machine-generated electrical, optical, or electromagnetic signal that is generated to encode information for transmission to suitable receiver apparatus.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various apparatus components in the embodiments described above should not be understood as requiring such separation in all embodiments, and it should be understood that the described program components and apparatus can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims.

1. An apparatus, for monitoring availability of parking spaces in a parking lot and warning of a possible collision of a vehicle with an object in the parking lot, comprising:
a controller;
at least one sensor electrically connected with the controller and constructed and arranged to detect availability of vehicle parking spaces in the parking lot and to identify one or more objects in or near at least one open parking space, in between occupied parking spaces, or in a roadway portion of the parking lot; and
at least one identifying module electrically connected with the controller, the identifying module, based on data from the at least one sensor, being constructed and arranged to identify an availability of parking spaces in an area of the parking lot;
wherein, based on data from the at least one sensor, the controller is constructed and arranged to cause an information signal to warn the driver of the vehicle, the vehicle itself, and/or the one or more objects of a possible collision between the vehicle and the one or more objects;
wherein the controller is constructed and arranged to cause the information signal when the at least one sensor detects that the one or more objects is in or near a parking space, is in between occupied parking space or in the roadway portion of the parking lot, and the vehicle is approaching the one or more objects.

2. (canceled)

3. The apparatus of claim 1, wherein the controller, the at least one sensor, and the at least one identifying module are integrated in a single component, or at least the controller and the at least one sensor are separated.

4. The apparatus of claim 3, further comprising at least one infrastructure component, the single component being mounted to the at least one infrastructure component.

5. The apparatus of claim 3, wherein the at least one infrastructure component comprises at least one of a post, a wall, a ceiling, or a support structure adjacent to the parking lot.

6. The apparatus of claim 1, wherein the at least one sensor comprises one of a radar sensor, a LIDAR sensor, a LADAR sensor, a camera, an ultrasound sensor, and a sonar sensor.

7. The apparatus of claim 1, further comprising lighting structure electrically connected with the identifying module, the lighting structure including lights such that an illuminated light of a certain color identifies the at least one open parking space.

8. The apparatus of claim 1, wherein the identifying module comprise one of a dedicated short range communication (DSRC) device, a V2X device, a LTE device and a WiFi device and is constructed and arranged to broadcast information regarding the availability of parking spaces, and to broadcast the information signal.

9. The apparatus of claim 1, wherein the at least one sensor is constructed and arranged to detect the one or more objects as a pedestrian, a vehicle, a bicyclist, pet, or a stationary object.

10. The apparatus of claim 1, wherein the information signal comprises a haptic warning.

11. A method of monitoring availability of parking spaces in a parking lot and warning of a possible collision of a vehicle with an object in the parking lot, the method comprising the steps of:
sensing availability of vehicle parking spaces in an area of the parking lot and identifying one or more objects in or near parking spaces, in between occupied parking spaces, or in a roadway portion of the area of the parking lot;
based on the sensing step, identifying an availability of parking spaces in the area of the parking lot; and
based on the sensing step, warning the driver of the vehicle, the vehicle itself, and/or the one or more objects of a possible collision between the vehicle and the one or more objects;
wherein the warning step occurs when the one or more objects is sensed in or near a parking space, in between occupied parking spaces, or in the roadway portion of the parking lot, and the vehicle is approaching the one or more objects.

12. (canceled)

13. The method of claim 11, wherein the sensing step is performed by at least one sensor, the identifying step is performed by at least one identifying module and the warning step is originated by a controller.

14. The method of claim 13, further comprising integrating the at least one sensor, the at least one identifying module, and the controller into a single component, or providing the at least one sensor separate from the controller.

15. The method of claim 14, further comprising mounting the single component to at least one infrastructure component.

16. The method of claim 15, wherein the at least one infrastructure component comprises at least one of a post, a wall, a ceiling, or a support structure adjacent to the parking lot.

17. The method of claim 11, wherein the sensing step employs at least one of a radar sensor, a LIDAR sensor, a LADAR sensor, a camera, an ultrasound sensor, and a sonar sensor.

18. The method of claim 11, wherein the identifying step includes illuminating, with a certain color light, the at least one open parking sp ace.

19. The method of claim 11, wherein the identifying step employs one of a dedicated short range communication (DSRC) device, a V2X, a LTE device and a WiFi device to broadcast information regarding the availability of parking spaces, and to provide the warning regarding a presence of the one or more objects.

20. The method of claim 11, wherein the sensing step senses as the one or more objects as a pedestrian, another vehicle, a bicyclist, a pet, or a stationary object, and wherein the step of warning includes generating an audible sound warning, a visual warning, or a haptic warning.
